(19) United States
(12) Patent Application Publication
(10) Pub. No.: US 2026/0327102 A1
(43) Pub. Date: Oct. 22, 2026

(54) Method and system for a point-of-use antimicrobial water filter using chitosan compounds for improving public health

(71) Applicants: Siri S Muppidi, Suwanee, GA (US); Srikar S Muppidi, Suwanee, GA (US)

(72) Inventors: Siri S Muppidi, Suwanee, GA (US); Srikar S Muppidi, Suwanee, GA (US)

(73) Assignees: Siri S Muppidi, Suwanee, GA (US); Srikar S Muppidi, Suwanee, GA (US)

(21) Appl. No.: 19/182,584

(22) Filed: Apr. 18, 2025

(51) Int. Cl. C02F 1/50; B01J 20/20; C02F 1/28; C08J 3/20

(52) U.S. Cl. CPC C02F 1/50; B01J 20/20; C02F 1/283; C08J 3/203; C02F 2303/04; C08J 2305/08

(57) ABSTRACT

The present invention relates to a multi-layer point-of-use water filtration system for improving public health outcomes. The system incorporates a chitosan activated carbon compound, activated carbon (AC), sand, and a ceramic element in a layered configuration. The chitosan compound serves as the primary antibacterial agent, while the activated carbon, sand, and ceramic layers work to enhance filtration efficiency and prevent chitosan leakage into purified water. The filter utilizes a specific ratio of chitosan compound, AC, and sand (1:1:2 by weight) to optimize antibacterial performance. The filter includes both heavy molecular weight and light molecular weight chitosan compounds, which provide equivalent antibacterial efficacy at different concentrations. The chitosan-AC compound is synthesized through a controlled process that is simple to implement. The filter is environmentally sustainable, as chitosan is a biodegradable biopolymer derived from natural sources. This novel filtration system provides an effective, eco-friendly solution for preventing the spread of waterborne diseases.

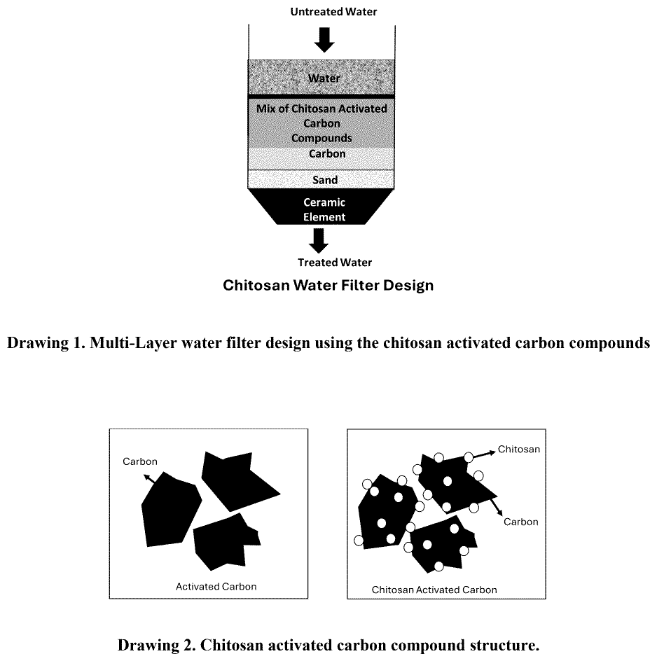

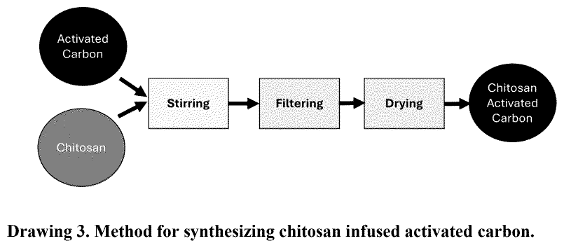

### BACKGROUND OF THE INVENTION

Water, the most basic necessity, sustains life on earth. However, many developing regions of the world still lack access to clean drinking water. In fact, 3.5 million people die from water-borne diseases annually, which is the single largest cause of death in the world today. Currently, ceramic water filters are used in many developing regions because their porous structures can trap particulate matter. Although this solution is environmentally friendly, and easily accessible, ceramic filters, along with most commercial-grade household water filters, lack antibacterial properties. Additionally, although the use of synthetic antibiotics for water treatment has been proposed, such a solution would worsen already pressing concerns of antimicrobial resistance, as many strains of water-borne bacteria have already become resistant to synthetic antibiotics. The challenge of designing an effective antibacterial water filter that is both environmentally friendly and globally accessible remains unresolved. The current invention addresses these issues by developing a multi layered point-of-use antibacterial water filter that is environmentally friendly and sustainable.

### BRIEF SUMMARY OF THE INVENTION

Ceramic water filters are widely used in many developing regions of the world because they are easily manufactured, inexpensive and widely accessible. However, these filters do not possess antibacterial properties, so enhancing their performance will have a wide impact and extensive applications.

Chitosan is the second largest natural biopolymer. It is available in sea shells, insects, crustaceans, and other natural sources. Chitosan has natural antibacterial properties that can be attributed to its unique molecular structure. It is biodegradable and sustainable. Chitosan is available in two forms heavy molecular weight chitosan (HMWC) and light molecular weight chitosan (LMWC). The use of chitosan as an antibacterial in compact point of use water filter is not known. The challenges with using chitosan stem from the fact that it is a dense substance and thick viscous liquid. This limits the delivery of chitosan for an antibacterial application in a point of use water filer as chitosan would obstruct the natural flow of water. Usage of pumps is not an option.

To solve these problems, a multilayered filter design that can efficiently deliver different types of chitosan for point of use water filtration has been developed. A process that can be used for the synthesis of these chitosan infused activated carbon compounds is proposed. The developed compounds are used as one of the layers in a filter along with other layers for activated carbon, sand and ceramic element. While chitosan provides the antibacterial properties of the filter, the other layers help in removing chitosan from filtered water as well decreasing the flow rate and increasing the contact and efficacy of the filter. Chitosan is a large polymeric molecule, that does not pass through other filter layers. The filter can be used a point of use antibacterial water filter that is environmentally friendly and sustainable.

The developed filter was tested for antibacterial performance by measuring the CFUs/mL of the filtered water and comparing it with the CFUs/mL of water filter without the chitosan-activated carbon compound to measure the benefit from the novel compound and filter.

### BRIEF DESCRIPTION OF THE SEVERAL VIEWS OF THE DRAWING

The following drawings have been included:

Drawing 1: Shows the block diagram of the concept of the point-of-use antibacterial water filter. The key part of the design is the usage of chitosan infused activated carbon as a layer in the filter.

Drawing 2: Structure of the developed chitosan activated compound. This structure increases the contact of chitosan with water which aids in increasing the contact time and area between the bacteria in the water and chitosan increasing the antibacterial efficiency of the filter. Further this provides an efficient delivery mechanism of chitosan to water filtration by not letting the viscosity of chitosan block the flow of water.

Drawing 3: Process that was developed for infusing chitosan onto activated carbon.

### DETAILED DESCRIPTION OF THE INVENTION

### Introduction

Chitosan, a byproduct of chitin, is widely available in natural sources such as shrimp, crabs, crawfish, and insects. As the world's second largest naturally occurring biopolymer, chitosan is an abundant and biodegradable resource. Chitosan's hydroxyl (—OH) and amino (NH₂) functional groups are thought to play an important role in its antibacterial properties. Chitosan binds to negatively charged bacterial cell walls, disrupting cellular operations and molecular exchanges across the cell membrane. It then attaches to bacterial DNA and inhibits DNA repair, accelerating cellular stress, which eventually leads to bacterial cell death.

Household water filters, including the widely popular ceramic filters, are not antibacterial. Using synthetic antibiotics is not an option for household water filters as it aids in antimicrobial resistance (AMR) which is a critical problem by itself. Further, the application and delivery of chitosan for water filtration in point of use scenarios is a challenge due to the viscosity and high density of chitosan. The usage of pumps is cost and also form factor prohibitive for point of use applications.

To solve these issues an innovative water filter using chitosan, a natural antibiotic agent, in order to treat water without contributing to antimicrobial resistance has been developed as part of this invention. This has been achieved by developing a compound by infusing chitosan onto activated carbon and using the compound as one of the layers in the filter along with other carefully chosen layers. The process to develop the compound is also part of this invention.

### Dosage and In Vitro Evaluation of Chitosan Types

The Kirby-Bauer Disk Diffusion Susceptibility Test was used for measuring the effectiveness of different types and concentration of chitosan. Agar plates were thoroughly inoculated with different concentrations of LMWC and HMWC chitosan. A filter paper disk was then soaked in each concentration of chitosan. Once the disks were fully soaked, they were carefully placed onto the agar plates and incubated at 37° C. for 24 hours. After the agar has properly diffused and the bacteria has grown, a clear zone of inhibition develops around the disks if the concentration of the specific chitosan used is effective. The zone of inhibition is proportional to the overall effectiveness of the antibiotic. These steps were repeated four times for a total of five trials. The average diameters of the inhibition zones for the various scenarios is shown in Table 1 and Table 2. The results showed that HMWC at half the concentration of LWMC has the same antibacterial performance. 4% LMWC has equivalent performance of 2% HWMC. Similarly 2% LMWC has equivalent performance as 1% HMWC. Bacterial growth was seen inside the inhibition zones of 1% LMWC. These results show that a concentration of at least 2% LMWC or 1% HMWC is required for effective treatment of water from natural sources.

TABLE 1
Diameter of the Zone of Inhibition with
Different Concentrations of HMWC Solution

| Diameter of | 4% | 2% | 1% | 0.5% |
|---|---|---|---|---|
| Inhibition Zone (mm) | LMWC | LMWC | LMWC | LMWC |
| Average | 36.32 | 27 | 17.4 | 14.6 |

TABLE 2
Diameter of the Zone of Inhibition with
Different Concentrations of HMWC Solution

| Diameter of | 2% | 1% |
|---|---|---|
| Inhibition Zone (mm) | HMWC | HMWC |
| Average | 35.2 | 29 |

### Chitosan-Carbon Compound

A mechanism that can effectively deliver chitosan to untreated water in point of use settings is currently unknown of. However, activated carbon (AC) has the potential to solve this issue. AC has a porous structure due to its microtubules, drastically increasing surface area to 32,000 ft² per gram of AC. Additionally, AC is also capable of adsorption. Due to these benefits, a novel compound made by adsorbing chitosan onto AC is being proposed. The high surface area of AC allows for increased contact between chitosan and the bacteria present in untreated water, when such water is to be purified.

The structure of the chitosan-AC compound in this invention is shown in Drawing 1. When used in a filter, water flows between the activated carbon particles that now hold molecules of chitosan on them. The bacteria in water come in contact with the chitosan and are eliminated from the water.

To synthesize the chitosan-AC compound the following process was developed as part of the invention. A mixture of chitosan and AC was agitated at 80° C. to deposit chitosan molecules onto AC, allowing the AC to adsorb the chitosan. This mixture was then added to a magnetic stirrer to ensure that the chitosan was uniformly distributed onto the AC. The mixture was filtered with filter paper and dried to extract the chitosan-AC compound. Two types of the compound are synthesized: one with LMWC and the other with HMWC. The process is shown in Drawing 3.

Water Filter Design with Chitosan Compound

Ceramic water filters are widely used in many developing regions of the world because they are easily manufactured, causing them to be inexpensive and widely accessible. However, these filters do not possess antibacterial properties, so enhancing their performance will have a wide impact and extensive applications. This goal can be achieved using the novel chitosan-AC compounds that were developed. Running water through a ceramic filter without chitosan serves as a baseline of the water quality in many parts of the world. Adding chitosan-AC compounds as a layer to this filter provides an accurate measurement of the benefit that is desired to be achieved. The design of the filter is shown in Drawing 1. In order to create the point of use filter, the chitosan-AC compound, AC and sand are used in the ratio 1:1:2 by weight to create the layers of the filter.

For example, if 4 grams of chitosan-AC compound is used, then the filter is built by adding in 8 grams of sand, followed by 4 grams of activated carbon layer and a top layer of 4 grams of chitosan-activated carbon compound. The ceramic element is left constant in the different trials. Chitosan-AC compound layer provides the antibacterial function of the filter.

### Performance Evaluation of the Filter

The efficacy of the proposed filter was evaluated by measuring the number of bacteria/mL in the treated water. The control group of this study is a water filter without the chitosan-AC compound. To measure the bacteria/mL, filtered water was cultured and the bacterial colonies were counted. Each colony is thought to have grown from a single bacterium, and by counting the number of colonies, the total amount of bacteria can be estimated. However, as the number of bacteria is expected to be too large to count, the serial dilution method is used.

In the serial dilution method 1 mL of the filtered water was diluted by 9 mL of distilled water. 1 mL of this solution was then diluted once again with 9 mL of distilled water. This process was repeated 3-4 times as needed. This allows the bacterial colonies to be counted using the viable cell count method.

After the sample was diluted to the desired factor, 0.1 mL was swabbed onto an agar plate and incubated at 32° C. for 24 hours. The number of Colony Forming Units (CFUs) were then counted. By counting the number of CFUs in the diluted sample, the number of CFUs in the original sample can be estimated using this formula:

$$\frac{CFUs}{mL} in water sample = \frac{CFUs on plate}{Volume in mL cultured} \cdot {10}^{N} \qquad ( 1 )$$

In order to evaluate the performance of the chitosan compounds developed and quantify the improvement filters the % efficacy of the filter is defined as below:

$$\% Efficacy = \frac{[ Final CFU - Initial CFU ] \cdot 100}{Initial CFU} \qquad ( 2 )$$

% Efficacy represents how much of the bacteria from the original sample was successfully removed by the compound. The % efficacy of the different filters is shown in Table 3.

TABLE 3
Efficacy of water filter with different compounds

| Compound | % Efficacy |
|---|---|
| Activated Carbon | 78.68% |
| LMWC Activated Carbon Compound | 99.63% |
| HMWC Activated Carbon Compound | 100% |

From the table it can be seen that AC filter eliminated approximately 78.68% of bacteria from the original sample on average. This is good improvement but LMWC-AC compound filters eliminate approximately 99.63% of bacteria from untreated water which is a significant improvement. HMWC-AC compound completely eliminated all bacteria. These results also show that when adjusted for concentration, both types HMWC and LMWC AC compounds can be mixed and used for an antibacterial filter.

1: A method of reducing bacterial contamination in water at the point of use, the method comprising:
(a) providing a multi-layer filtration device for water purification, wherein the device comprises:
(i) a mix of chitosan activated carbon compounds layer with specific antibacterial strength,
(ii) an activated carbon (AC) layer,
(iii) a sand layer,
(iv) a ceramic element;
(b) the chitosan compound, activated carbon, and sand being used in a weight ratio of 1:1:2, respectively;
(c) passing water through the multi-layer filtration device such that the efficacy of chitosan compounds is increased by other layers,
wherein the antibacterial properties of the chitosan compound help reduce bacteria in the water and improve public health outcomes.

2: The method of claim 1, wherein the additional layers of activated carbon layer, sand layer, and ceramic element increase the filtration efficiency by:
(a) preventing leakage of the chitosan compound into the purified water, and
(b) increasing the contact time between the chitosan compound and the water, thereby enhancing the antibacterial action of the chitosan.

3: The method of claim 1, wherein the filter incorporates multiple types of chitosan compounds derived from activated carbon, including:
(a) at least 1% heavy molecular weight chitosan (HMWC), and
(b) at least 2% light molecular weight chitosan (LMWC),
wherein the combination of these chitosan compounds enhances the desired antibacterial performance of the filter.

4: The method of claim 1, wherein the antibacterial efficacy of heavy molecular weight chitosan (HMWC) at half the concentration is equivalent to the antibacterial efficacy of light molecular weight chitosan (LMWC) at double the concentration,
for example, 2% HMWC provides the same bacterial efficacy as 4% LMWC, and 1% HMWC provides the same bacterial efficacy as 2% LMWC.

5: The method of claim 1, wherein the chitosan compounds are synthesized by a process comprising:
(a) agitating a mixture of chitosan and activated carbon (AC) at 80° C. to deposit chitosan molecules onto the activated carbon,
(b) using a magnetic stirrer to ensure uniform distribution of chitosan onto the activated carbon,
(c) filtering and drying the mixture to extract the chitosan-AC compound.

6: The method of claim 1, wherein all the materials including sand and ceramic are environmentally friendly and sustainable, with chitosan being the second most abundant biopolymer in nature and biodegradable.
